(19) United States
(12) Patent Application Publication
(10) Pub. No.: US 2009/0073551 A1
(43) Pub. Date: Mar. 19, 2009

(54) ELECTRICALLY-OPERATED MICROSCOPE

(75) Inventor: Daisuke Kato, Ina-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Olympus Corporation, Tokyo (JP)

(21) Appl. No.: 12/184,422

(22) Filed: Aug. 1, 2008

(30) Foreign Application Priority Data
Sep. 14, 2007 (JP) 2007-240040

(51) Int. Cl. G02B 21/00

(52) U.S. Cl. 359/368

(57) ABSTRACT

The present invention provides an electrically-operated microscope including an arrangement switching unit, a driving unit, an operation inputting unit, and a control unit. The arrangement switching unit holds a plurality of optical elements and switches an arrangement of the plurality of optical elements. The driving unit drives the arrangement switching unit. The operation inputting unit inputs a predetermined single operation. The control unit controls the driving unit to control the arrangement of the plurality of optical elements, and performs a control of stopping a driving of the driving unit and enabling a manual revolution of the arrangement switching unit when the predetermined single operation is input by the operation inputting unit.

### CROSS-REFERENCE TO RELATED APPLICATIONS

This application is based upon and claims the benefit of priority from Japanese Patent Application No. 2007-240040, filed on Sep. 14, 2007, the entire contents of which are incorporated herein by reference.

### BACKGROUND OF THE INVENTION

1. Field of the Invention

The present invention relates to an electrically-operated microscope including an electrically-operated arrangement switching device which holds a plurality of optical elements including an interchangeable optical element, and switches an arrangement of the optical elements depending on a sample.

2. Description of the Related Art

Conventionally, an electrically-operated microscope equipped with an arrangement switching device has been known, for example in Japanese Patent Application Laid-Open No. 2003-90960, the arrangement switching device (an electrically-operated revolver and an electrically-operated filter turret, for example) holding a plurality of optical elements (objective lenses and filters, for example) and electrically switching an arrangement of the optical elements. The conventional arrangement switching device makes a turret having a plurality of optical elements thereon revolve by using a motor, so that a desired optical element is arranged on an optical path.

### SUMMARY OF THE INVENTION

An electrically-operated microscope according to an aspect of the present invention includes an arrangement switching unit which holds a plurality of optical elements and switches an arrangement of the plurality of optical elements; a driving unit which drives the arrangement switching unit; an operation inputting unit which inputs a predetermined single operation; and a control unit which controls the driving unit to control the arrangement of the plurality of optical elements, and performs a control of stopping a driving of the driving unit and enabling the arrangement switching unit to revolve manually when the predetermined single operation is input by the operation inputting unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a side view schematically showing a microscope system according to a first embodiment of the present invention;

FIG. 2 is a plan view schematically showing the microscope system according to the first embodiment of the present invention;

FIG. 3 is a schematic view of a structure of a drive controlling mechanism of a transmission turret;

FIG. 4 is a schematic view of a structure of a drive controlling mechanism of arrangement switching devices;

FIG. 5 is a flow chart showing a procedure of an arrangement switching processing performed by a transmission turret controller from a start-up of the microscope system shown in FIG. 1 to a shut-off of a power source;

FIG. 6 is a plan view schematically showing a microscope system according to a second embodiment of the present invention;

FIG. 7 is a flow chart showing a procedure of an arrangement switching processing performed by a fluorescent cube turret controller when a fluorescent cube interchanging door shown in FIG. 2 is opened;

FIG. 8 is a flow chart showing a procedure of a processing performed by the fluorescent cube turret controller when the fluorescent-cube-interchanging door is opened in a microscope system according to a third embodiment of the present invention;

FIG. 9 is a plan view schematically showing a microscope system according to a fourth embodiment of the present invention;

FIG. 10A is a side view of a fluorescent cube shown in FIG. 9;

FIG. 10B is a plan view of the fluorescent cube shown in FIG. 9;

FIG. 11 is a schematic view of a structure of a drive controlling mechanism of a fluorescent cube turret according to a modification of the fourth embodiment of the present invention;

FIG. 12A is a side view of a fluorescent cube shown in FIG. 11; and

FIG. 12B is a plan view of the fluorescent cube shown in FIG. 11.

### DETAILED DESCRIPTION OF THE PREFERRED EMBODIMENTS

Exemplary embodiments of an electrically-operated microscope according to the present invention will be explained below with reference to the accompanying drawings. It should be noted that the present invention is not limited by the embodiments, and that the identical part is assigned with the same symbol in the description throughout the drawings.

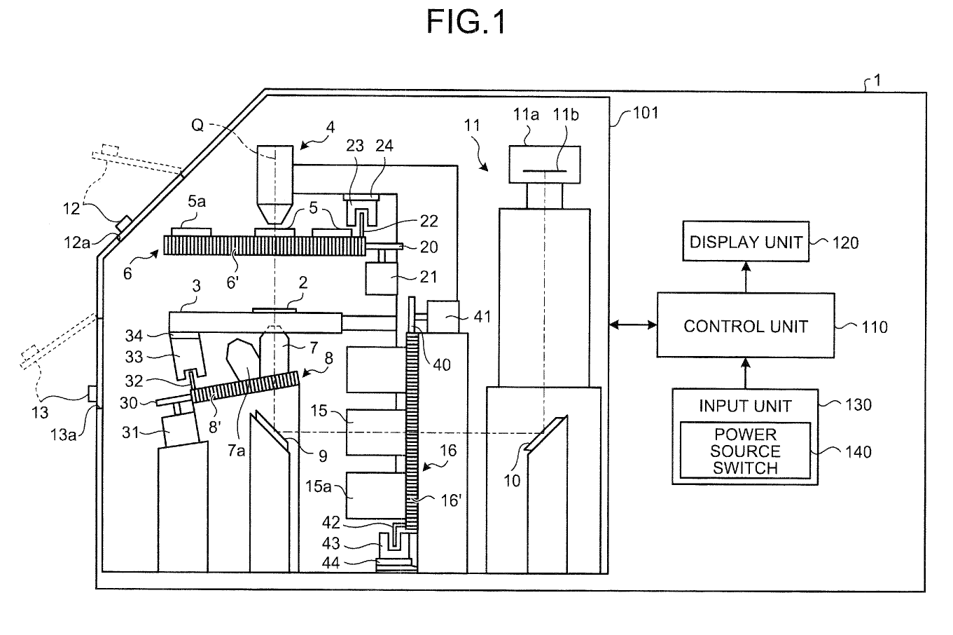

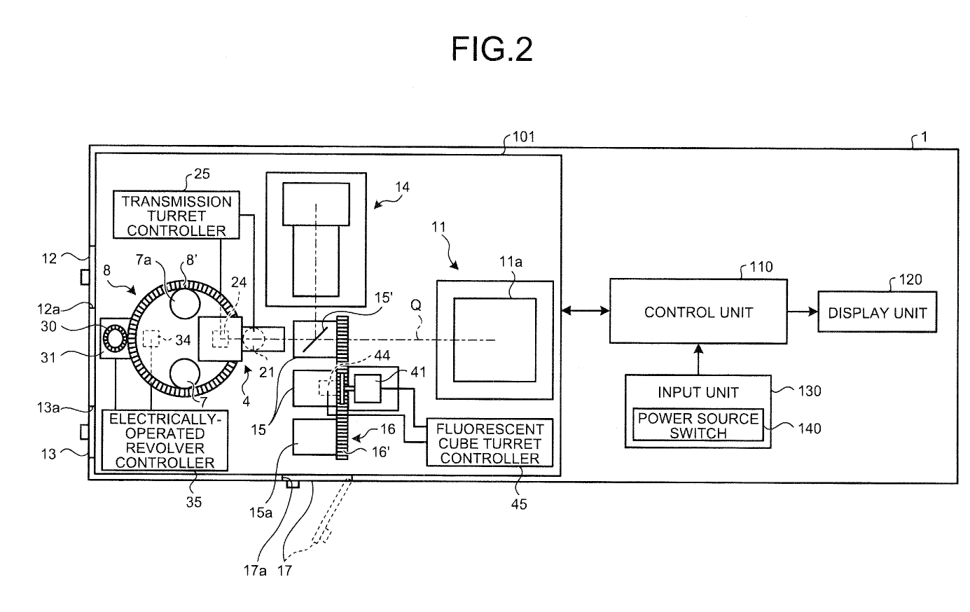

First, a microscope system (an electrically-operated microscope) according to a first embodiment of the present invention will be explained. FIG. 1 is a side view schematically showing a microscope system 1 according to the first embodiment. FIG. 2 is a plan view schematically showing the microscope system 1. As shown in FIG. 1, the microscope system 1, being an inverted microscope, includes an observation mechanism 101, a controller 110, a display unit 120, an input unit 130, and a power source switch 140. The observation mechanism 101 serves as a mechanism for observing a sample The controller 110 controls an operation of each part of the microscope system 1. The display unit 120 displays an image and the like of the sample imaged in the observation mechanism 101. The input unit 130 allows inputting various operations. The power source switch 140 allows commanding to start up the microscope system 1, and to turn on and off a power source.

As shown in FIG. 1, the observation mechanism 101 has a stage 3 on which a sample 2 is placed. The observation mechanism 101 further has a transmitting light source 4 as a light source used for a transmitting illumination and a transmission turret 6 at vertically upper position of the stage 3, and has an electrically-operated revolver 8 and a reflection mirror 9 which reflects a transmitting light at vertically lower position of the stage 3. The observation mechanism 101 still further has a reflection mirror 10 and an imaging device 11.

The transmission turret 6 holds a plurality of filters 5 each of which allows transmitting only a desired transmitting light and arranges one, suitable for an observation of the sample 2, of the filters 5 on an optical axis Q. A filter 5a out of the plurality of filters 5 can be interchanged by a user. The user opens a filter interchanging door 12 to change the filter 5a, the filter interchanging door 12 covering an opening 12a corresponding to an interchange position in a manner of being freely opened and closed.

The electrically-operated revolver 8 has a plurality of objective lenses 7 and arranges desired one of the plurality of objective lenses 7 on the optical axis Q. An objective lens 7a out of the plurality of objective lenses 7 can be interchanged by the user. The user opens an objective lens interchanging door 13 to change the objective lens 7a, the objective lens interchanging door 13 covering an opening 13a corresponding to an interchange position in the manner of being freely opened and closed.

As shown in FIG. 1, a light emitted from the transmitting light source 4 goes through the filter 5 followed by the sample 2, and goes into the objective lens 7. The observation light having passed through the objective lens 7 is reflected by the reflection mirrors 9 and 10 and goes into the imaging device 11. Then, the observation light comes to be incident on a surface of a charge-coupled diode (CCD) 11b of a camera 11a provided in the imaging device 11. In this manner, an image of the sample 2 is captured.

As shown in FIG. 2, the observation mechanism 101 also has an incident light source 14 as a light source used for an incident-light illumination and a fluorescent cube turret 16. The fluorescent cube turret 16 has a plurality of fluorescent cubes 15 and arranges one, suitable for the observation of the sample 2, of the fluorescent cubes 15 between the reflection mirrors 9 and 10 on the optical axis Q. Each fluorescent cube 15 integrally has an exciting-light transmitting filter, a fluorescence transmitting filter, and a dichroic mirror 15′. The exciting-light transmitting filter selectively transmits an exciting light for exciting the sample 2. The fluorescence transmitting filter selectively transmits a fluorescence emitted from the sample 2 excited by the exciting light. The dichroic mirror 15′ transmits the fluorescence while reflecting the exciting light. A fluorescent cube 15a out of the plurality of fluorescent cubes 15 can be interchanged by the user. The user opens a fluorescent cube interchanging door 17 to change the fluorescent cube 15a, the fluorescent cube interchanging door 17 covering an opening 17a corresponding to an interchange position in the manner of being freely opened and closed.

As shown in FIG. 2, the exciting light emitted from the incident light source 14 goes into the fluorescent cube 15, is reflected by the dichroic mirror 15′, and is incident on the reflection mirror 9. The exciting light then excites the sample 2 after passing through the objective lens 7. Similarly to the transmitting light, the fluorescence emitted from the excited sample 2 goes through the objective lens 7, is reflected by the reflection mirror 9, goes through the fluorescent cube 15, is further reflected by the reflection mirror 10, and then goes into the imaging device 11. In this manner, a fluorescent image of the sample 2 is captured.

The controller 110 is realized by a microcomputer having a memory function of storing information such as a sample image and a program with a processing of each part of the microscope system 1. The controller 110 is electrically connected to each part of the observation mechanism 101, the display unit 120, the input unit 130, and the power source switch 140, and controls the processing of each part of the microscope system 1.

The display unit 120 is realized by a liquid crystal display and the like and displays the image of the sample 2 captured by the imaging device 11 and information of various kinds.

The input unit 130 is realized by, for example, a keyboard and a mouse, and inputs a signal according to an input operation to the controller 110. The user uses the input unit 130 to input information of the sample 2 and the like to the controller 110. Further, the input unit 130 has the power source switch 140. The user turns on or off the power source switch 140 to start up the microscope system 1 or shut off the power source.

In the first embodiment, the filters 5, the objective lenses 7, and the fluorescent cubes 15 are configured to be optical elements, while the transmission turret 6, the electrically-operated revolver 8, and the fluorescent cube turret 16 each as a device to switch an arrangement of its own optical elements being configured to be arrangement switching devices.

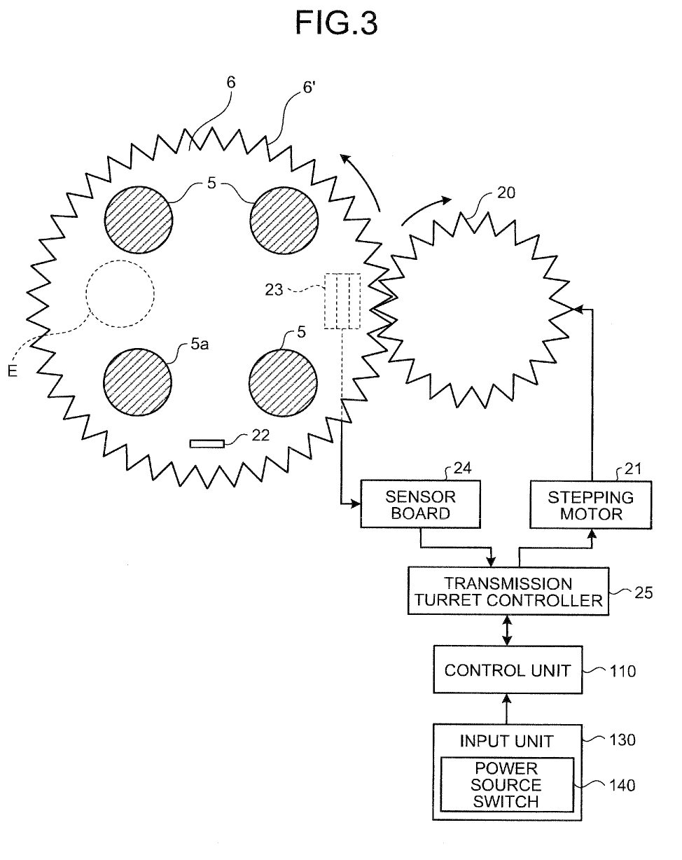

Next, a mechanism of switching the arrangement of the optical elements by the arrangement switching device will be explained. Specifically, a mechanism of switching the arrangement of the filters 5 by the transmission turret 6 will be explained. FIG. 3 is a schematic view of a structure of the transmission turret 6 and a mechanism of controlling a driving of the transmission turret 6. As shown in FIG. 3, the transmission turret 6, having substantially circular shape, holds the plurality of filters 5 along a circumference of a concentric circle smaller than the transmission turret 6. The transmission turret 6 is provided with a gear 6′ along its outer circumference. The gear 6′ engages with a gear 20 which, having substantially circular shape, revolves in the circumferential direction by a stepping motor 21.

By driving the stepping motor 21, the gear 20 revolves and the transmission turret 6 revolves according to the revolution of the gear 20, thereby moving the filters 5 along the circumferential direction. A transmission turret controller 25 controls the number of steps to be input to the stepping motor 21, thereby controlling an amount of revolution of the transmission turret 6 and the arrangement of the filters 5.

When the power source of the microscope system 1 is shut off and a power feeding to the stepping motor 21 is stopped, that is, when the driving of the stepping motor 21 is stopped, the transmission turret 6 can revolve manually.

On the transmission turret 6, an indicator 22 which passes through a sensor 23 once per one revolution of the transmission turret 6 is provided. When a sensor substrate 24 detects the passage of the indicator 22 through the sensor 23, the sensor substrate 24 inputs a passage signal to the transmission turret controller 25. Here, the sensor 23 is realized by a photo interrupter of a transmission type and the like.

When the microscope system 1 is started up, the transmission turret controller 25 makes the transmission turret 6 revolve, detects the indicator 22, and makes the transmission turret 6 revolve to a reference position. Here, the reference position indicates a position where the transmission turret 6 is located as a result of a revolution of a predetermined degree after the indicator 22 has passed through the sensor 23. The transmission turret controller 25 memorizes an arrangement of the filters 5 when the transmission turret 6 is located at the reference position. The transmission turret controller 25 inputs a predetermined number of steps to the stepping motor 21 on the basis of the arrangement, thereby arranging one, indicated by the controller 110, of the filters 5 on the optical axis Q. The transmission turret 6 may have a plurality of indicators. In this case, the transmission turret controller 25 grasps the position of the filters 5 based on passage signals of the plurality of indicators, and arranges the indicated one of the filters 5 on the optical axis Q.

When the user performs an operation of turning off the power source switch 140, that is, an operation of shutting off the power source of the microscope system 1, the controller 110 inputs a signal of staring the processing of shutting off the power source to the transmission turret controller 25. The transmission turret controller 25, when receiving the input of this signal, performs a processing of arranging the filter 5a at an interchange position E. Here, the interchange position E is a position where the filters 5 are located nearest to the filter interchanging door 12 on the transmission turret 6. When the filter 5a is arranged at the interchange position E, the user can change the filter 5a.

Besides, each of the electrically-operated revolver 8 and the fluorescent cube turret 16 switches an arrangement of its own optical elements, similarly to the transmission turret 6. As shown in FIG. 1, the electrically-operated revolver 8 is provided with a gear 8′ along its outer circumference. The gear 8′ engages with a gear 30 which, having substantially circular shape, revolves in the circumferential direction by the stepping motor 31 and causes the electrically-operated revolver 8 to revolve accordingly. When the driving of the stepping motor 31 is stopped, the electrically-operated revolver 8 can revolve manually, similarly to the transmission turret 6. On the electrically-operated revolver 8, an indicator 32 is provided. When the indicator 32 passes through a sensor 33, a sensor substrate 34 inputs a passage signal to an electrically-operated revolver controller 35.

In addition, as shown in FIG. 1, the fluorescent cube turret 16 is provided with a gear 16′ along its outer circumference. The gear 16′ engages with a gear 40 which revolves in the circumferential direction by the stepping motor 41 and causes the fluorescent cube turret 16 to revolve accordingly. When the driving of the stepping motor 41 is stopped, the fluorescent cube turret 16 can revolve manually, similarly to the transmission turret 6. On the fluorescent cube turret 16, an indicator 42 is provided. When the indicator 42 passes through a sensor 43, a sensor substrate 44 inputs a passage signal to a fluorescent cube turret controller 45.

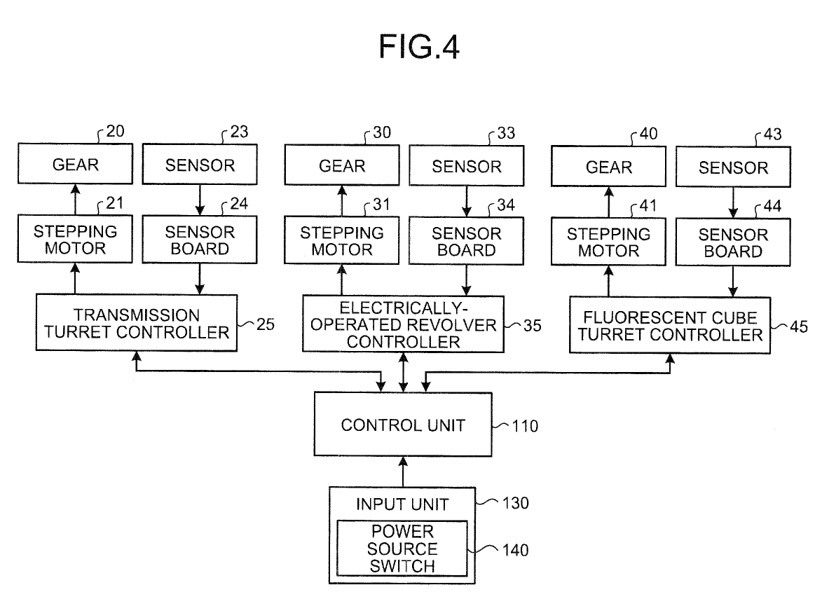

As shown in FIG. 4, the electrically-operated revolver controller 35 receives the input of the passage signal of the indicator 32 from the sensor substrate 34, controls the driving of the stepping motor 31, and arranges one, indicated by the controller 110, of the objective lenses 7 at a predetermined position, similarly to the transmission turret controller 25. In the same way, the fluorescent cube turret controller 45 receives the input of the passage signal of the indicator 42 from the sensor substrate 44, controls the driving of the stepping motor 41, and arranges one, indicated by the controller 110, of the fluorescent cubes 15 at a predetermined position.

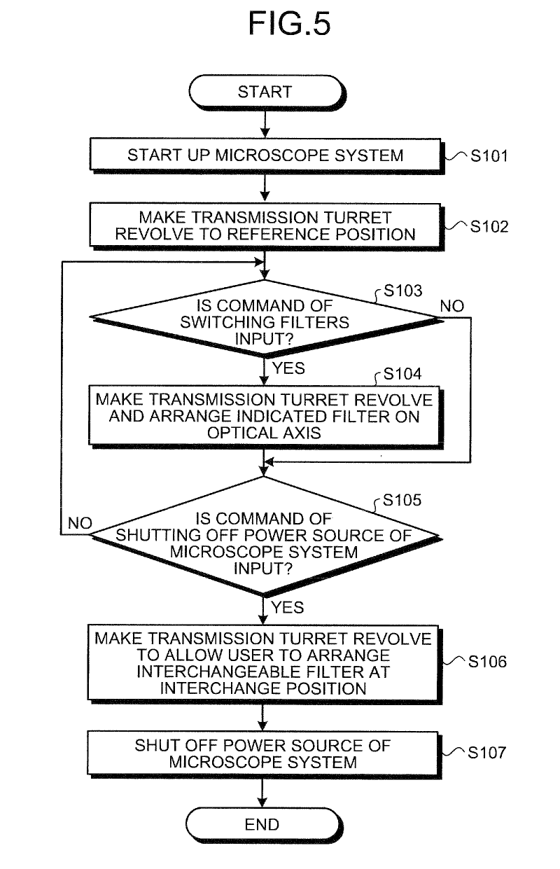

Next, a procedure of an arrangement switching processing of the optical elements from the start-up of the microscope system 1 to the shut-off of the power source will be explained with reference to FIG. 5, by taking a processing, performed by the transmission turret controller 25, of switching the arrangement of the filters 5 as an example. First, when a signal of staring the microscope system 1 is input (step S101), the transmission turret controller 25 makes the transmission turret 6 revolve to the reference position (step S102). After that, the transmission turret controller 25 waits for an input indicating a switchover of the arrangement of the filters 5 (step S103). When the input indicating the switchover of the arrangement of the filters 5 is performed (“Yes” at step S103), the transmission turret controller 25 makes the transmission turret 6 revolve and arranges indicated one of the filters 5 on the optical axis Q (step S104). In this case, the user uses the filter 5 arranged on the optical axis Q to capture the image of the sample 2. When the input indicating the switchover of the arrangement of the filters 5 is not performed (“No” at step S103), the transmission turret controller 25 does not perform the switchover of the arrangement of the filters 5. In this case, the user uses the filter 5 present on the optical axis Q when the transmission turret 6 is located at the reference position to capture the image of the sample 2.

Then, the transmission turret controller 25 waits for an input of a signal of shutting off the power source of the microscope system 1 (step S105). Until the time of receiving the input of the signal of shutting of the power source (“No” at step S105), the transmission turret controller 25 performs the processing from step S103 to S104. When the signal of shutting off the power source of the microscope system 1 is input (“Yes” at step S105), the transmission turret controller 25 makes the transmission turret 6 revolve and arranges the filter 5a at the interchange position E (step S106). Then, the controller 110 shuts off the power source of the microscope system 1 (step S107).

The electrically-operated revolver controller 35 performs an arrangement switching processing of the optical elements, similarly to the transmission turret controller 25. When the signal of starting to shut off the power source of the microscope system 1 is input, the electrically-operated revolver controller 35 arranges the objective lens 7a at the interchange position which is not shown. In the same way, when the signal of starting to shut off the power source of the microscope system 1 is input, the fluorescent cube turret controller 45 arranges the fluorescent cube 15a at the interchange position which is not shown.

In the first embodiment as described, the user can easily change the interchangeable optical element since the interchangeable optical element can be easily arranged at the interchange position by performing the operation of turning off the power source switch 140, that is, the single operation of shutting off the power source of the microscope system 1.

Furthermore, since the user changes the interchangeable optical element after the shut-off of the power source in the first embodiment, the arrangement switching device never operates automatically and thereby the interchangeable optical element can be easily changed. Besides, since the user changes the interchangeable optical element in a state that the lights of the transmitting light source 4 and the incident light source 14 are turned off, the interchangeable optical element can be easily changed without a leakage of the illumination light.

In addition, when each arrangement switching device has a plurality of interchangeable optical elements in the microscope system 1, the controller of each arrangement switching device performs a control of arranging a predetermined optical element out of the interchangeable optical elements at the interchange position.

Next, a microscope system according to a second embodiment will be explained. In the first embodiment, when the single operation of shutting off the power source of the microscope system is input, the interchangeable optical element is arranged at the interchange position. However, in the second embodiment, when a single operation of opening an interchanging door which covers an opening corresponding to the interchange position is input, the interchangeable optical element is arranged at the interchange position.

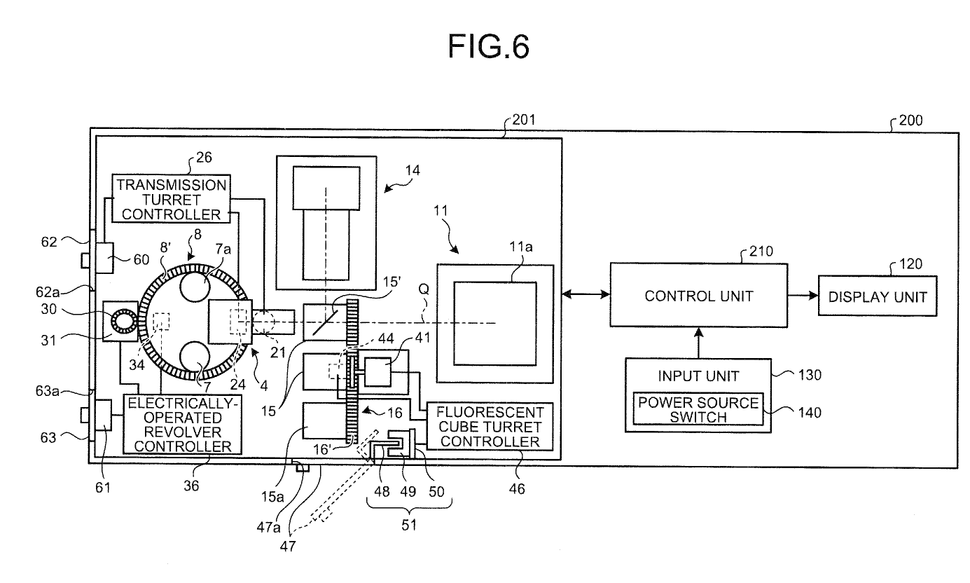

FIG. 6 is a view schematically showing a structure of a microscope system 200 according to the second embodiment. As shown in FIG. 6, an observation mechanism 201 of the microscope system 200 has a fluorescent cube interchanging door 47 and a fluorescent cube turret controller 46 instead of the fluorescent cube interchanging door 17 and the fluorescent cube turret controller 45 provided in the microscope system 1. The fluorescent cube interchanging door 47, which covers an opening 47a corresponding to the interchange position in the manner of being freely opened and closed, includes an indicator 48. The observation mechanism 201 further has a sensor 49 which detects the indicator 48 and a sensor substrate 50 which is electrically connected to the sensor 49. The sensor 49 is realized by the photo interrupter of a transmission type and the like.

As shown in FIG. 6, when the fluorescent cube interchanging door 47 is closed, the sensor 49 can detect the indicator 48 since the indicator 48 is present within the sensor 49. On the other hand, when the fluorescent cube interchanging door 47 is opened, the sensor 49 cannot detect the indicator 48 since the indicator 48 gets out of the sensor 49. Both when the sensor 49 detects the indicator 48 after a state that the indicator 48 is undetectable, and when the sensor 49 does not detect the indicator 48 after a state that the indicator 48 is detectable, the sensor 49 inputs signals respectively to the sensor substrate 50. Based on the signals, when the fluorescent cube interchanging door 47 is opened, the sensor substrate 50 inputs an opened-door signal to that effect to the fluorescent cube turret controller 46, and when the fluorescent cube interchanging door 47 is closed, the sensor substrate 50 inputs a closed-door signal to that effect to the fluorescent cube turret controller 46. Here, the indicator 48, the sensor 49, and the sensor substrate 50 are collectively treated as a signal input unit 51.

In addition to the processing performed by the fluorescent cube turret controller 45, the fluorescent cube turret controller 46 controls the stepping motor 41 to make the fluorescent cube turret 16 revolve at a speed lower than a normal revolution speed when the opened-door signal is input. The fluorescent cube turret controller 46 arranges the fluorescent cube 15a at the interchange position and then performs a processing of stopping the driving of the stepping motor 41. Here, the normal revolution speed means a revolution speed of the fluorescent cube turret 16 when the fluorescent cube interchanging door 47 is closed.

Besides, the observation mechanism 201 has a filter interchanging door 62 and a transmission turret controller 26 instead of the filter interchanging door 12 and the transmission turret controller 25 provided in the microscope system 1. The filter interchanging door 62 covers an opening 62a corresponding to the interchange position in the manner of being freely opened and closed. The observation mechanism 201 also has a signal input unit 60 which inputs the opened-door signal and the closed-door signal with respect to the filter interchanging door 62 to the transmission turret controller 26, similarly to the signal input unit 51.

The observation mechanism 201 further has an objective lens interchanging door 63 and an electrically-operated revolver controller 36 instead of the objective lens interchanging door 13 and the electrically-operated revolver controller 35 provided in the microscope system 1. The objective lens interchanging door 63 covers an opening 63a corresponding to the interchange position in the manner of being freely opened and closed. The observation mechanism 201 also has a signal input unit 61 which inputs the opened-door signal and the closed-door signal with respect to the objective lens interchanging door 63 to the electrically-operated revolver controller 36, similarly to the signal input unit 51.

The microscope system 200 includes a controller 210 instead of the controller 110 provided in the microscope system 1. The controller 210 controls a processing of each part of the microscope system 200. Other components in the microscope system 200 are the same as those in the microscope system 1.

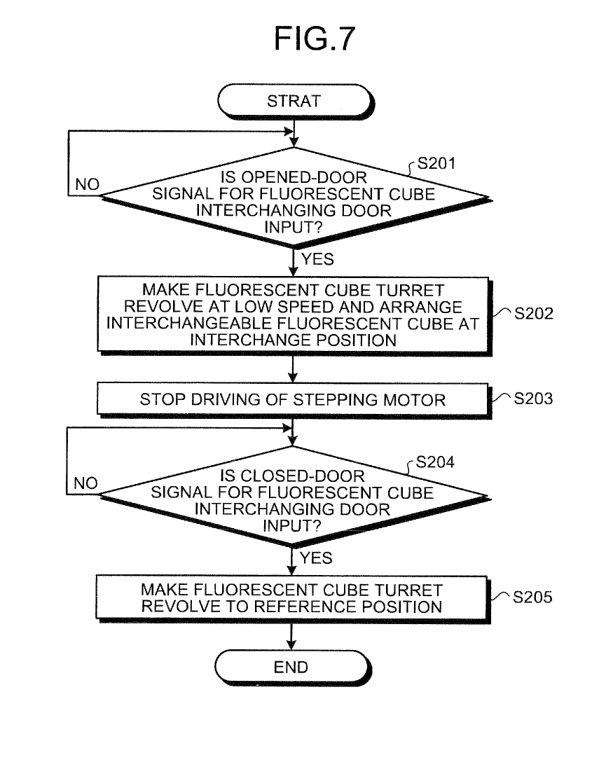

Next, a procedure of a processing, performed by the fluorescent cube turret controller 46, of switching the arrangement of the optical elements will be explained with reference to FIG. 7. First, the fluorescent cube turret controller 46 waits for the opened-door signal with respect to the fluorescent cube interchanging door 47 (step S201). When the opened-door signal is input (“Yes” at step S201), the fluorescent cube turret controller 46 makes the fluorescent cube turret 16 revolve at a low speed, and arranges the fluorescent cube 15a at the interchange position (step S202). After that, the fluorescent cube turret controller 46 stops the driving of the stepping motor 41 (step S203). The fluorescent cube turret controller 46 then waits for the closed-door signal with respect to the fluorescent cube interchanging door 47 (step S204). When the closed-door signal is input (“Yes” at step S204), the fluorescent cube turret controller 46 re-starts the driving of the stepping motor 41 and makes the fluorescent cube turret 16 revolve to the reference position (step S205).

The transmission turret controller 26 performs the processing of arranging the filter 5a at the interchange position E at a low speed when the filter interchanging door 62 is opened, similarly to the fluorescent cube turret controller 46. The electrically-operated revolver controller 36 performs the processing of arranging the objective lens 7a at the interchange position at a low speed when the objective lens interchanging door 63 is opened, similarly to the fluorescent cube turret controller 46.

In the second embodiment as described, the user can easily change the interchangeable optical element since the interchangeable optical element can be easily arranged at the interchange position by performing the single operation of opening the interchanging door corresponding to a desired interchangeable optical element.

Furthermore, even when the user opens the interchanging door during the revolution of the arrangement switching device in the second embodiment, the arrangement switching device stops after the revolution speed becomes lower than the normal revolution speed and thereby the interchangeable optical element can be easily changed.

However, the revolution speed of the arrangement switching device after the interchanging door is opened may not necessarily be lower. In other words, when the interchanging door is opened, the interchangeable optical element may be arranged at the interchange position at a revolution speed equivalent to the normal revolution speed. In addition, when each arrangement switching device has a plurality of interchangeable optical elements, the controller of each arrangement switching device performs a control of arranging a predetermined optical element out of the interchangeable optical elements at the interchange position.

Next, a third embodiment of the present invention will be explained. When a predetermined single operation is performed in the first and the second embodiments, the interchangeable optical element is arranged at the interchange position, and then the driving of the stepping motor is stopped. However, in the third embodiment, when a single operation of opening the interchanging door which covers the opening corresponding to the interchange position is performed, the driving of the stepping motor is stopped without switching the arrangement of the optical elements.

A microscope system according to the third embodiment is constituted by the same structure as the microscope system 200, and the transmission turret controller 26, the electrically-operated revolver controller 36, and the fluorescent cube turret controller 46 control the driving of the stepping motors 21, 31, and 41 according to opening and closing of the interchanging doors, respectively.

For example, when the opened-door signal with respect to the fluorescent cube interchanging door 47 is input, the fluorescent cube turret controller 46 performs a control of stopping a power feeding to the stepping motor 41 to stop the driving of the stepping motor 41. When the driving of the stepping motor 41 is stopped, the fluorescent cube turret 16 can revolve manually, however, does not revolve by itself since the gear 16′ and the gear 40 are in meshing engagement with each other.

Additionally, identifying information which allows discriminating the fluorescent cube 15a from the other fluorescent cubes 15 is recorded on an outer surface of the fluorescent cube 15a. Therefore, the user can easily arrange the fluorescent cube 15a at the interchange position by manually rotating the fluorescent cube turret 16 while checking the identifying information.

When the closed-door signal with respect to the fluorescent cube interchanging door 47 is input, the fluorescent cube turret controller 46 re-starts the power feeding to the stepping motor 41 to re-start the driving of the stepping motor 41. Here, there is a case where the fluorescent cube turret 16 has revolved manually by the user while the fluorescent cube interchanging door 47 is opened. Therefore, the fluorescent cube turret controller 46 makes the fluorescent cube turret 16 revolve to the reference position after re-starting the driving of the stepping motor 41, and again grasps the arrangement relationship between the optical axis Q and each of the fluorescent cubes 15.

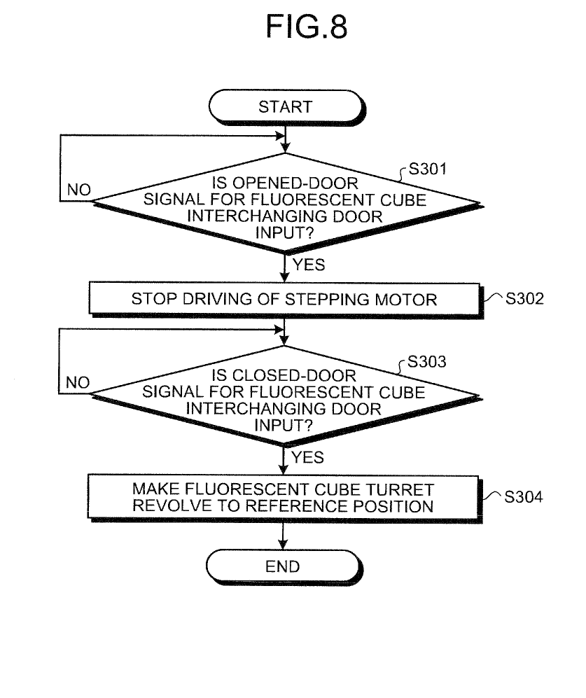

Next, a procedure of a processing, performed by the fluorescent cube turret controller 46, of controlling the stepping motor 41 will be explained with reference to FIG. 8. First, the fluorescent cube turret controller 46 waits for the opened-door signal with respect to the fluorescent cube interchanging door 47 (step S301). When the opened-door signal is input (“Yes” at step S301), the fluorescent cube turret controller 46 stops the driving of the stepping motor 41 (step S302).

After that, the fluorescent cube turret controller 46 waits for the closed-door signal with respect to the fluorescent cube interchanging door 47 (step S303). When the closed-door signal is input (“Yes” at step S303), the fluorescent cube turret controller 46 re-starts the driving of the stepping motor 41 to make the fluorescent cube turret 16 revolve to the reference position (step S304).

Each of the transmission turret controller 26 and the electrically-operated revolver controller 36 performs a processing of controlling each of the stepping motors 21 and 31, similarly to the processing, performed by the fluorescent cube turret controller 46, of controlling the stepping motor 41. Besides, identifying information, similarly to the fluorescent cube 15a, is recorded on each outer surface of the filter 5a and the objective lens 7a.

In the third embodiment as described, the user can easily change the interchangeable optical element since the arrangement switching device holding a desired interchangeable optical element can revolve manually by performing the single operation of opening the interchanging door corresponding to the desired interchangeable optical element.

In the microscope system according to the third embodiment, the driving of the arrangement switching device may be stopped to allow the manual revolution of the arrangement switching device even when the power source of the microscope system is shut off via the operation of turning off the power source switch 140. Thus, in the third embodiment, the driving of the arrangement switching device may be stopped to allow the manual revolution of the arrangement switching device by shutting off the power source of the entirety of the microscope system when any one of the interchanging doors is opened. In this case, since the driving of the entirety of the microscope system is stopped, the user can easily change the interchangeable optical element.

Besides, the microscope system according to the third embodiment may have a plurality of interchangeable optical elements for each arrangement switching device. In this case, it is necessary to record information of identifying each optical element on the outer surface of each optical element, in advance. The user opens the interchanging door, visually recognizes the identifying information of each optical element via the manual revolution of the arrangement switching device, and specifies a desired interchangeable optical element.

Next, a fourth embodiment of the present invention will be explained. In the first and the second embodiments, each arrangement switching device has one interchangeable optical element, and the interchangeable optical element is arranged at the interchange position when a predetermined single operation is performed. However, in the fourth embodiment, each arrangement switching device has a plurality of interchangeable optical elements, and a predetermined optical element out of the plurality of the interchangeable optical elements is arranged at the interchange position when a predetermined single operation is input.

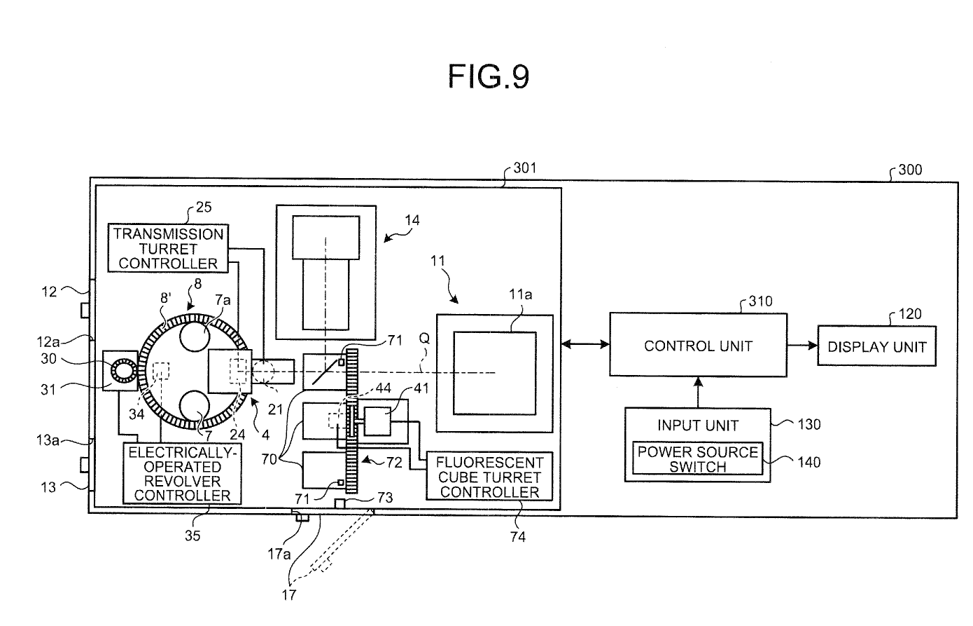

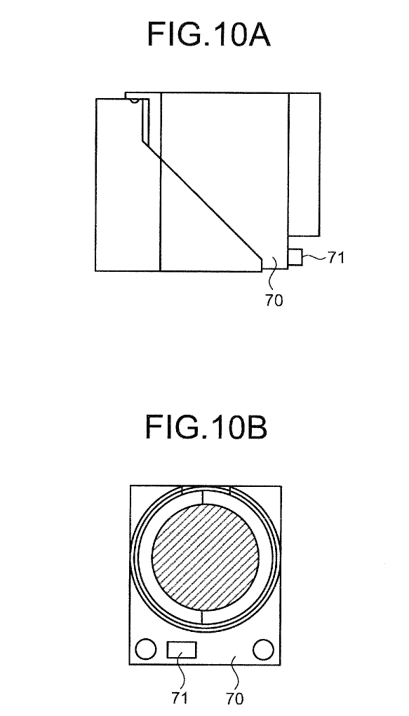

FIG. 9 is a view schematically showing a microscope system 300 according to the fourth embodiment. As shown in FIG. 9, an observation mechanism 301 of the microscope system 300 has a fluorescent cube 70, a fluorescent cube turret 72, and a fluorescent cube turret controller 74 instead of the fluorescent cubes 15 and 15a, the fluorescent cube turret 16, and the fluorescent cube turret controller 45. As shown in FIGS. 10A and 10B, the fluorescent cube 70 is a fluorescent cube constituted by the fluorescent cube 15 embedded with an IC chip 71. The fluorescent cube turret 72 holds a plurality of fluorescent cubes 70 similarly to the fluorescent cube turret 16, however, does not has the indicator 22. The observation mechanism 301 further has an IC reader/writer 73 instead of the sensor 43 and the sensor substrate 44 provided in the microscope system 1. The IC reader/writer 73 reads information recorded in the IC chip 71 and writes information about a frequency of use, a position on the fluorescent cube turret 72, and the like into the IC chip 71. In addition, the microscope system 300 includes a controller 310 instead of the controller 110 provided in the microscope system 1. Other components in the microscope system 300 are the same as those in the microscope system 1.

The controller 310 inputs a signal of starting up the microscope system 300 to the fluorescent cube turret controller 74 when receiving the operation of turning on the power source switch 140. The fluorescent cube turret controller 74 which has received the signal makes the fluorescent cube turret 72 revolve 360 degrees. By this revolution, the fluorescent cube turret controller 74 makes the IC reader/writer 73 read the information of all the fluorescent cubes 70 held by the fluorescent cube turret 72, and grasps the arrangement of the fluorescent cubes 70. Then, the fluorescent cube turret controller 74 arranges one, indicated by the controller 310, of the fluorescent cubes 70 on the optical axis Q.

Besides, the controller 310 displays information of each fluorescent cube 70 on the display unit 120. The user can select a desired interchangeable fluorescent cube 70, that is, one of the interchangeable fluorescent cubes 70 each as a candidate based on the displayed information. The user uses the input unit 130 to input information which specifies the desired one of the interchangeable fluorescent cubes 70. In this manner, the user can specify one of the interchangeable fluorescent cubes 70 without actually opening the fluorescent cube interchanging door 17 to visually recognize the fluorescent cubes 70. Any one of the interchangeable fluorescent cubes 70 each as a candidate may be specified automatically by the controller 310 based on the information of the frequency of use and the like.

When a signal of starting the processing of shutting off the power source of the microscope system 300 is input, the fluorescent cube turret controller 74 controls the pre-specified one candidate out of the interchangeable fluorescent cubes 70 at the interchange position, similarly to the fluorescent cube turret controller 45.

In the microscope system 300 as described, the user can arrange desired one of the interchangeable fluorescent cubes 70 at the interchange position by performing the single operation of shutting off the power source of the microscope system 300.

Though the microscope system 300 is explained by taking the fluorescent cube turret 72 among the arrangement switching devices as an example, the transmission turret 6 can arrange a desired one of the interchangeable filters 5 at the interchange position, and the electrically-operated revolver 8 can arrange a desired one of the interchangeable objective lenses 7 at the interchange position in the same manner.

Thus, even when a plurality of interchangeable optical elements are provided, the user can easily change any one of the interchangeable optical elements since any one of the interchangeable optical elements is arranged at the interchange position by the single operation of shutting off the power source of the microscope system.

The microscope system 300 is configured to include the IC chip 71 and the IC reader/writer 73 based on the structure of the microscope system 1, however, may be configured to include the same based on the structure of the microscope system 200. In other words, a predetermined optical element out of the plurality of the interchangeable optical elements may be arranged at the interchange position when the single operation of opening the interchanging door is performed.

In the fourth embodiment, when a predetermined single operation is performed, a desired one of the interchangeable optical elements each as a candidate is arranged at the interchange position. However, when a predetermined single operation is performed in a modification of the fourth embodiment, any one of empty holes in which no optical element is fitted among holes (fitting holes) for holding the optical element on each arrangement switching device is arranged at the interchange position.

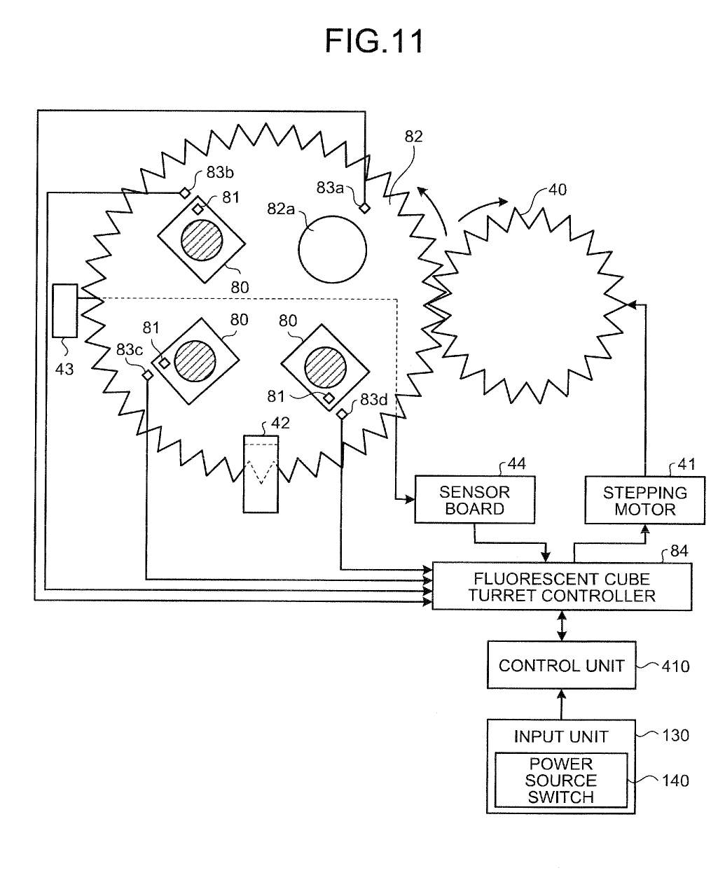

FIG. 11 is a schematic view of a structure of a fluorescent cube turret 82 according to the modification and a mechanism of controlling a driving of the fluorescent cube turret 82. As shown in FIG. 11, a microscope system according to the modification includes a fluorescent cube 80, the fluorescent cube turret 82, a fluorescent cube turret controller 84, and a controller 410 instead of the fluorescent cubes 15 and 15′, the fluorescent cube turret 16, the fluorescent cube turret controller 45, and the controller 110 provided in the microscope system 1. Other components in the microscope system according to the modification are the same as those in the microscope system 1.

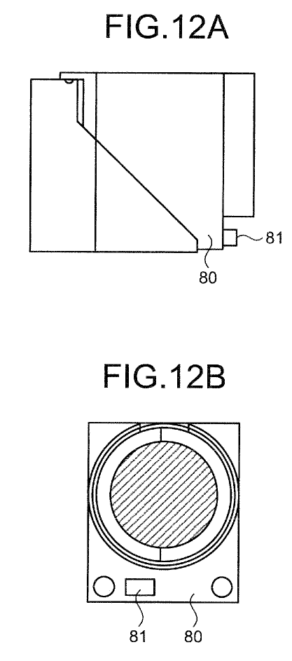

The fluorescent cube turret 82 has four fitting holes. In FIG. 11, three holes out of the four holes are fitted with the fluorescent cubes 80, and a fitting hole 82a is an empty hole. The fluorescent cube turret 82 further has magnetic sensors 83a, 83b, 83c, and 83d. As shown in FIGS. 12A and 12B, each fluorescent cube 80 has a magnet 81 instead of the IC chip 71 provided in the fluorescent cube 70. When the fluorescent cube 80 is fitted in each fitting hole, the magnetic sensors 83a to 83d detect the magnet 81 and input a detection signal to the fluorescent cube turret controller 84. The fluorescent cube turret controller 84 determines whether each fitting hole is empty or not based on the detection signal.

When a signal of staring a processing of shutting off the power source of the microscope system is input, the fluorescent cube turret controller 84 performs a control of arranging the empty hole at the interchange position. In the case shown in FIG. 11, the fluorescent cube turret controller 84 performs a control of making the fluorescent cube turret 82 revolve and arranging the fitting hole 82a at the interchange position which is not shown. When a plurality of empty holes including the fitting hole 82a are present, the fluorescent cube turret controller 84 arranges any one of the empty holes at the interchange position.

In the microscope system according to the modification as described, the user can arrange the fitting hole 82a at the interchange position by performing the single operation of shutting off the power source of the microscope system.

Though the microscope system according to the modification is explained by taking the fluorescent cube turret 82 among the arrangement switching devices as an example, each of the transmission turret 6 and the electrically-operated revolver 8 can arrange an empty hole at the interchange position in the same manner.

Thus, according to the modification, the user can easily place an optical element since the empty hole on the arrangement switching device can be arranged at the interchange position by the single operation of shutting off the power source of the microscope system.

The microscope system according to the modification is configured to include the magnet 81 and the magnetic sensors 83a to 83d based on the structure of the microscope system 1, however, may be configured to include the same based on the structure of the microscope system 200. In other words, the empty hole on the arrangement switching device may be arranged at the interchange position when the single operation of opening the interchanging door is performed.

In the first to fourth embodiments and the modification, the operation of shutting off the power source of the microscope system or the operation of opening the interchanging door is treated as a predetermined single operation, and the processing of arranging an interchangeable optical element at the interchange position or the processing of enabling a manual revolution of the arrangement switching device is performed when the predetermined single operation is input. However, the operation is not limited to those described above, and the processing may be performed when any single operation is input.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An electrically-operated microscope, comprising:
an arrangement switching unit which holds a plurality of optical elements and switches an arrangement of the plurality of optical elements;
a driving unit which drives the arrangement switching unit;
an operation inputting unit which inputs a predetermined single operation; and
a control unit which controls the driving unit to control the arrangement of the plurality of optical elements, and performs a control of stopping a driving of the driving unit and enabling the arrangement switching unit to revolve manually when the predetermined single operation is input by the operation inputting unit.

2. The electrically-operated microscope according to claim 1, wherein the control unit, before performing the control of enabling the arrangement switching unit to revolve manually, controls the driving unit to make an interchangeable optical element among the plurality of optical elements move to an interchange position which allows an operation of changing the interchangeable optical element.

3. The electrically-operated microscope according to claim 1, wherein the operation inputting unit is a power source switch and inputs an operation of shutting off a power source as the predetermined single operation.

4. The electrically-operated microscope according to claim 1, further comprising an interchanging door which covers an opening corresponding to an interchange position which allows an operation of changing an interchangeable optical element among the plurality of optical elements, wherein the operation inputting unit is the interchanging door and inputs an operation of opening the interchanging door as the predetermined single operation.

5. The electrically-operated microscope according to claim 4, wherein the control unit controls, before performing the control of enabling the arrangement switching unit to revolve manually, the driving unit to make the plurality of optical elements move at a speed lower than a normal revolution speed when an interchangeable optical element among the plurality of optical elements is moved to the interchange position.

6. The electrically-operated microscope according to claim 2, further comprising a recognizing unit which recognizes the plurality of optical elements held by the arrangement switching unit, wherein the control unit controls the driving unit to move a desired one of the plurality of optical elements at the interchange position based on information recognized by the recognizing unit.
